(19) United States
(12) Patent Application Publication
(10) Pub. No.: US 2004/0118102 A1
(43) Pub. Date: Jun. 24, 2004

(54) Wide-angle concentric diffuser

(75) Inventor: Malcolm S. Child, South Berwick, ME (US)

Correspondence Address: MICHAEL BEST & FRIEDRICH LLP, 3773 CORPORATE PARKWAY, SUITE 360, CENTER VALLEY, PA, 18034-8217, US

(73) Assignee: Ingersoll-Rand Energy Systems Corporation, Portsmouth, NH

(21) Appl. No.: 10/726,196

(22) Filed: Dec. 2, 2003

Related U.S. Application Data
(60) Provisional application No. 60/432,151, filed on Dec. 10, 2002.

(51) Int. Cl. F02C 7/10

(52) U.S. Cl. 60/39.511

(57) ABSTRACT

A wide-angle diffuser for a combustion turbine system having a turbine provides multiple expanding flow paths for the turbine exhaust. Each flow path is arranged to have the ideal diffusion angle for the given flow thus allowing for complete and efficient expansion of the turbine exhaust with a shorter length diffuser. An inner tube having an ideal diffusion angle is surrounded by a plurality of frustoconical tubes having larger opening angles producing a plurality of interstitial flow paths.

### FIELD OF THE INVENTION

The invention relates generally to combustion turbine systems for use in power generation and more specifically to combustion turbine systems having a turbine/generator assembly, a recuperator, and an exhaust diffuser communicating between the turbine/generator assembly and the recuperator.

### BACKGROUND OF THE INVENTION

Combustion turbines of the type described herein include a combustor that burns fuel and compressed air to create a flow of products of combustion, a turbine/generator assembly that generates electricity in response to the expansion of the products of combustion and that creates a flow of exhaust gases, and a recuperator that uses the heat from the exhaust gases to preheat the compressed air that is fed to the combustor. A diffuser is often interposed between the turbine and the recuperator to reduce the flow velocity of the flow of exhaust gases prior to the exhaust gases entering the recuperator. Known diffusers slow down the flow of exhaust gases by providing an expanding flow path for the exhaust gases.

### SUMMARY OF THE INVENTION

The invention provides a combustion turbine engine that includes a recuperator, a compressor, a source of fuel, a combustor, a radial flow turbine, an electric generator, a diffuser, and a plenum. The recuperator has a hot gas flow path and a cool gas flow path. The compressor provides a flow of compressed gas to the cool gas flow path of the recuperator, and the compressed gas is heated within the recuperator. The source of fuel provides a flow of fuel to the combustor, which mixes the fuel with the heated compressed air and combusts the mixture to produce a flow of hot gas. The radial flow turbine receives the flow of hot gas from the combustor and discharges a flow of exhaust gas. A rotating element in the turbine rotates in response to the flow of hot gas through the turbine. The electric generator generates electricity in response to rotation of the rotating element of the turbine.

The diffuser receives the flow of exhaust from the turbine. The diffuser includes at least two nested frustoconical members that define at least two separate flow paths for the flow of exhaust through the diffuser. The diffuser has an inlet end defining an inlet flow area, and an outlet end defining an outlet flow area that is larger than the inlet flow area. The diffuser reduces the flow rate of the flow of exhaust as the flow of exhaust flows from the inlet end to the outlet end. The plenum delivers the flow of exhaust from the diffuser to the hot gas flow path of the recuperator such that the exhaust gas heats the compressed gas within the recuperator.

The ratio of the diffuser outlet area to the diffuser inlet area may be, for example, between about 3 to 1 and about 7 to 1, or even between about 4 to 1 and about 5 to 1. The diffuser may reduce the flow rate of turbine exhaust from about 800 ft./sec. to about 50 to 100 ft./sec., for example. The diffuser may also include struts that interconnect inner and outer nested frustoconical members to provide additional stability to the assembly. The struts may, for example, be substantially tangent to the outer surface of the inner frustoconical member. Alternatively, the struts may be radially oriented and extend through the walls of the inner and outer frustoconical members.

Other features and advantages of the invention will become apparent to those skilled in the art upon review of the following detailed description, claims, and drawings.

### BRIEF DESCRIPTION OF THE DRAWINGS

FIG. 1 is a perspective view of a microturbine engine embodying the invention.

FIG. 2 is a cross-section view of a portion of the engine.

FIG. 3 is a perspective view of a mounting flange for the diffuser with the diffuser illustrated in partial phantom extending away from the mounting flange.

FIG. 4 is a end view of an alternative diffuser construction.

FIG. 5 is a perspective view of the diffuser of FIG. 4.

FIG. 6 is an enlarged view of one of the struts in the diffuser of FIG. 4.

Before one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein is for the purpose of description and should not be regarded as limiting. The use of “including” and “comprising” and variations thereof herein is meant to encompass the items listed thereafter and equivalents thereof as well as additional items.

### DETAILED DESCRIPTION

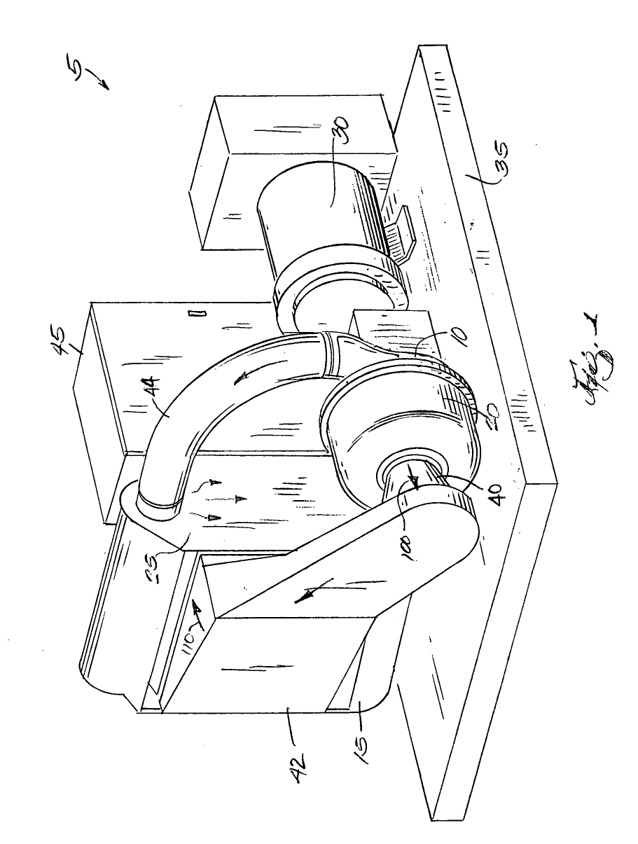

FIG. 1 illustrates a combustion turbine system 5 including a compressor 10, a combustor or combustion section 15, a radial flow turbine 20, a recuperator 25, a generator 30, a frame 35, and a diffuser 40. A plenum 42 communicates between the diffuser 40 and the hot gas inlet side of the recuperator 25. A pressurized gas conduit 44 communicates between compressor 10 and the cool gas inlet side of the recuperator 25. Many arrangements of these components are possible, including turbines 20 arranged with horizontal as well as vertical exhausts, and the invention is intended to work with all arrangements of turbines 20. The system frame 35 is constructed of steel or other known materials, and should be capable of rigidly supporting the components of the system. The frame 35 also includes an electrical cabinet 45 containing the system controls. The generator 30 is attached to the frame 35 and produces an electrical power output at the desired voltage and frequency in response to operation of the turbine 20.

The compressor 10 draws in atmospheric air along its central axis, compresses the air to a pressure in the range of 3 to 5 atmospheres, and then discharges the compressed air into cool gas inlet side of the recuperator 25 through the pressurized gas conduit 44. The compressed air flows through the recuperator 25, where it is heated as will be discussed below, and then into the combustion section 15. Fuel is mixed with the compressed air in the combustion section 15, and the air/fuel mixture is burned in the combustor section 15 to create an expanding flow of products of combustion.

The flow of products of combustion expands in the turbine 20, which causes the turbine 20 to rotate. Rotation of the turbine drives the compressor 10 and the generator 30 to create compressed air and electricity, respectively. The hot gas flowing through the turbine 20 is capable of reaching temperatures in excess of 1000° F. The exhaust gas from the turbine 20 flows through the diffuser 40 and plenum 42, and then into to the hot gas inlet side of the recuperator 25. The diffuser 40 reduces the flow rate of the exhaust gas, as will be discussed below, to more evenly distribute the exhaust gas across the hot gas inlet side of the recuperator 25.

While a single turbine system has been described, a system having two turbines is within the scope of the invention. In a two-turbine system, the first or gasifier turbine is typically operably coupled to the compressor 10. The flow of products of combustion leaving the combustion section 15 enters the first turbine and expands to drive the compressor 10. The flow of products of combustion then exits the first turbine and enters the second or power turbine, which is used to drive the generator 30.

Virtually any form of recuperator 25 may be used in the combustion turbine system 5, provided the recuperator 25 is able to withstand the internal pressures created by the compressed air, and the temperatures of the exhaust gases. A preferred recuperator 25, however, is a plate-fin crossflow type recuperator 25 having separate flow paths for the compressed air and the exhaust gases. The heat from the exhaust gases is transferred to the compressed air to preheat the compressed air prior to it being fed to the combustor 15. Heat transfer fins are used within the recuperator to increase the efficiency of the heat transfer from the exhaust gases to the compressed air. Preheating the compressed air increases the efficiency of the system 5.

The recuperator 25 functions most efficiently when an even flow of exhaust gases enters all levels of the recuperator 25. To achieve this distribution of exhaust gases, the flow rate of exhaust gases exiting the turbine 20 must be slowed before the flow of exhaust gases reaches the recuperator 25. The flow of exhaust gases exiting the turbine 20 commonly has a flow rate of approximate 800 feet per second. To achieve the desired distribution of exhaust gas flow to all levels of the recuperator 25, the flow rate must be reduced to approximately 50 to 100 feet per second. The diffuser 40 is used to achieve the desired reduction in exhaust gas flow rate in an efficient manner (i.e., with as little pressure drop in the flow of exhaust gases as possible).

Pressure drop across the diffuser 40 is minimized by achieving a desired area ratio between the diffuser inlet flow area 50 and the diffuser outlet flow area 55 (e.g., the diffuser outlet flow area 55 divided by the diffuser inlet flow area 50). Preferably, the area ratio is between 4 to 1 and 5 to 1, but the area ratio may alternatively be as low as 3 to 1 or as high as 7 to 1. Pressure drop is also minimized by constructing the diffuser to expand from the inlet to the outlet at a diffusion angle of around 7 degrees or less. The boundary layer of the flow of exhaust gases in the diffuser will typically not separate from the diffuser walls if the diffusion angle is around 7 degrees. Inefficiencies can arise when the diffusion angle is too large. More specifically, the flow of exhaust gases may separate from the diffuser walls, thereby creating relative low-pressure regions, eddies, turbulence and other inefficiencies in the flow of exhaust gases.

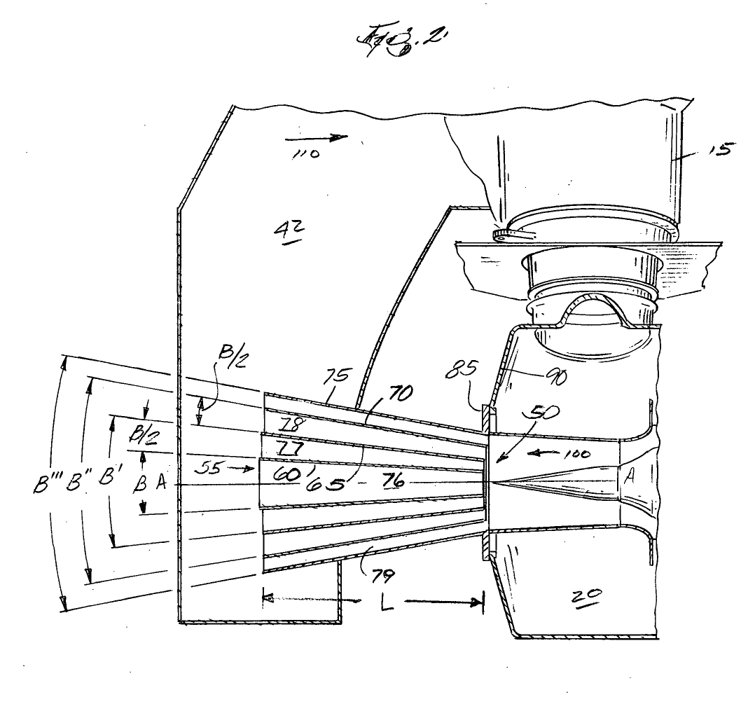

The diffuser 40 used in the illustrated system 5 is best illustrated in FIGS. 2 and 3. The diffuser includes a plurality of frustoconical members such as an inner tube 60, a first outer tube 65, a second outer tube 70, and an outermost tube or shell 75. The tubes 60, 65,70,75 are manufactured from sheet steel or other thin sheet material suitable for diffuser 40 manufacture. For example, low alloy steel or stainless steel sheet material may be used. The material choice is based on several factors including the combustion gas make-up, temperature, and pressure.

The tubes 60, 65, 70 are nested within the shell 75, and each of the tubes 60, 65, 70, 75 includes an outlet and an inlet defining the respective outlet and inlet flow areas 50, 55. The inlets of the tubes 60, 65, 70, 75 are generally aligned or coplanar with each other, as are the outlets of the tubes 60, 65, 70, 75. The tubes 60, 65, 70, 75 are frustoconical in shape. The inner tube 60 includes a tube wall that defines a conical flow path 76. The inner tube 60 and the first outer tube 65 act as walls that define a first interstitial flow path 77 therebetween, the first and second outer tubes 65, 70 act as walls that define a second interstitial flow path 78 therebetween, and the second outer tube 70 and the shell 75 act as walls that define a third interstitial flow path 79 therebetween. The flow of exhaust gases from the turbine 20 flow through the conical flow path 76 and through the first, second, and third interstitial flow paths 77, 78, 79.

In a preferred construction, illustrated in FIGS. 2 and 3, the tubes 60, 65, 70, 75 are nested such that their respective longitudinal axes are collinear and coincident with the diffuser longitudinal axis A-A. This arrangement produces interstitial flow paths 77, 78, 79 which are annular in shape. It is contemplated however, that the tubes 60, 65, 70, 75 could be arranged such that their axes are not collinear, or even parallel, thus producing non-annular flow paths 77, 78, 79.

The tubes 60, 65, 70, 75 are characterized by opening angles β, β′, β″, and β′″, respectively, and each of the flow paths 76, 77, 78, 79 is characterized by a diffusion angle. As used herein, the term “opening angle” means the angle at which the wall of each frustoconical tube 60, 65, 70, 75 increases in diameter from the inlet to the outlet. The diffusion angle for each flow path 76, 77, 78, 79 is the angle between the walls of a flow path. The diffusion angle for the inner tube 60 is equal to its opening angle β. The diffusion angle for the other flow paths 77, 78, 79 is half of the difference between the two opening angles of the tubes that define the flow path. For example, the illustrated construction provides an inner tube 60 with an opening angle β of 7° and an adjacent tube 65 with an opening angle β′ of 14°. In this construction, the diffusion angle of the interstitial path defined by the two tubes would be (14°-7°)/2 or 3.5° (e.g., β/2 as in FIG. 2). Other constructions use different opening angles as is appropriate for the particular application.

To reduce the likelihood of boundary layer separation in the flow paths 76, 77, 78, 79, the diffusion angles are preferably less than 5°, and are most preferably 3.5° or less. In the illustrated construction, P is about 7°, β′ is about 14°, β″ is about 21°, and β′″ is about 22°. The diffusion angles for the flow paths are therefore about 7° for the conical flow path 76, about 3.5° for each of the first and second interstitial flow paths 77, 78, and about 0.5° for the third interstitial flow path 79. The desired area ratio is attained over a relatively short length L when compared to the length of a traditional diffuser having a single conical tube. It should be noted that the diffuser may include fewer or even more nested conical tubes than those illustrated. Also, the opening angle β′″ may be as large as 180° in theory.

Because the tubes 60, 65, 70, 75 are constructed of thin sheet material, the tube walls have sufficient flexibility to accommodate expansion due to temperature cycles. The thin walled tubes also maximize the gas flow area for a given inlet area 50. Further, the use of thin walled tubes simplifies the manufacturing process by permitting the tubes to be rolled using relatively low energy, low cost processes. Finally, the thin walled tubes are relatively light and simplify the support structure. More specifically, the support structure includes support struts 80 that are relatively thin and have round cross-sections. Each set of struts attaches one tube to the adjacent outer tube. Thus, the struts 80 each block a portion of one interstitial flow path. Because they are thin, however, the struts 80 have minimal effect on the flow of exhaust gases through the flow paths 77, 78, 79. The relatively thin struts 80 also accommodate the temperature changes better than the thick struts that are typically required for thicker walled tubes.

Like the tubes 60, 65, 70, 75, the struts 80 are prone to expansion and contraction in response to the extreme temperatures to which they are exposed. To accommodate this expansion, the struts 80 are positioned in a manner that allows for their movement while still supporting the tubes to which they are attached. Each strut 80 attaches to two adjacent tubes. A first end of the strut 80 attaches to the outermost tube using any suitable attachment method, with welding being preferred. A second end of the strut 80 attaches to the innermost tube such that the strut 80 resides substantially on a line tangent to the innermost of the two tubes. Slots 81 are cut into the tubes 65, 70 to receive the struts 80. Preferably, three struts 80 are used for each nested tube to promote stability. In addition, many constructions employ three struts 80 at the inlet end of the diffuser 40 and three struts 80 at the outlet end of the diffuser 40.

During operation, the temperature of the struts increases dramatically in response to the flow of hot turbine exhaust gas therethrough. The increase in temperature causes thermal expansion of the strut. Thus, the strut gets longer. To accommodate the increase in length, the innermost of the two tubes rotates about the diffuser longitudinal axis relative to the outermost of the two tubes.

A flange 85 is attached (e.g., by welding or any other suitable attachment means) to the inlet end 50 of the outer shell 75, and facilitates attachment of the diffuser 40 to a turbine volute case 90. The flange 85 has a plurality of holes 95, through which bolts or screws may be extended to secure the flange 85 to the volute case 90. For sealing purposes, a gasket may be employed between the flange 85 and the volute case 90, or a metal-to-metal seal can be used.

The position of the diffuser 40 allows for a complete reversal in the flow direction of the turbine exhaust gas. The gas exits the turbine traveling in a first direction 100 and enters the recuperator 25 traveling in a second direction 110. In the illustrated construction, the second direction 110 is substantially opposite the first direction 100.

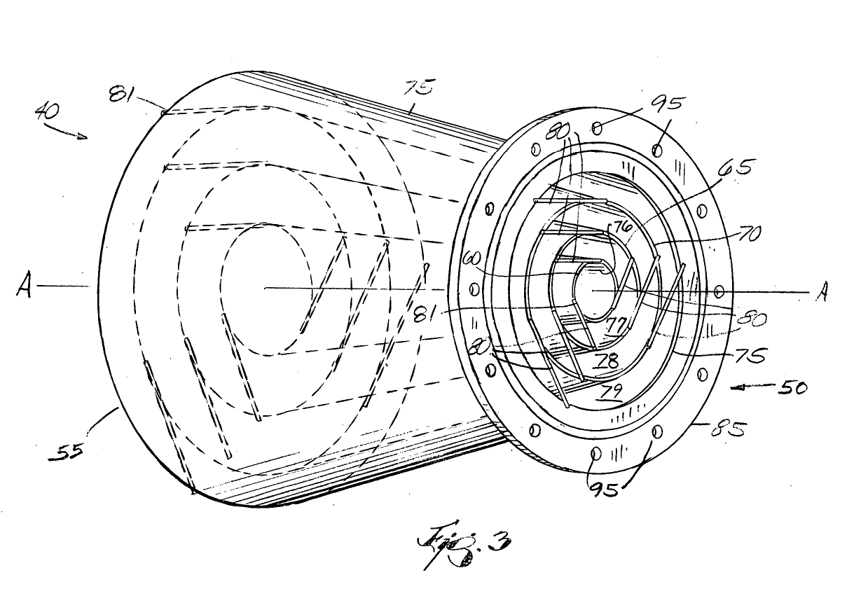

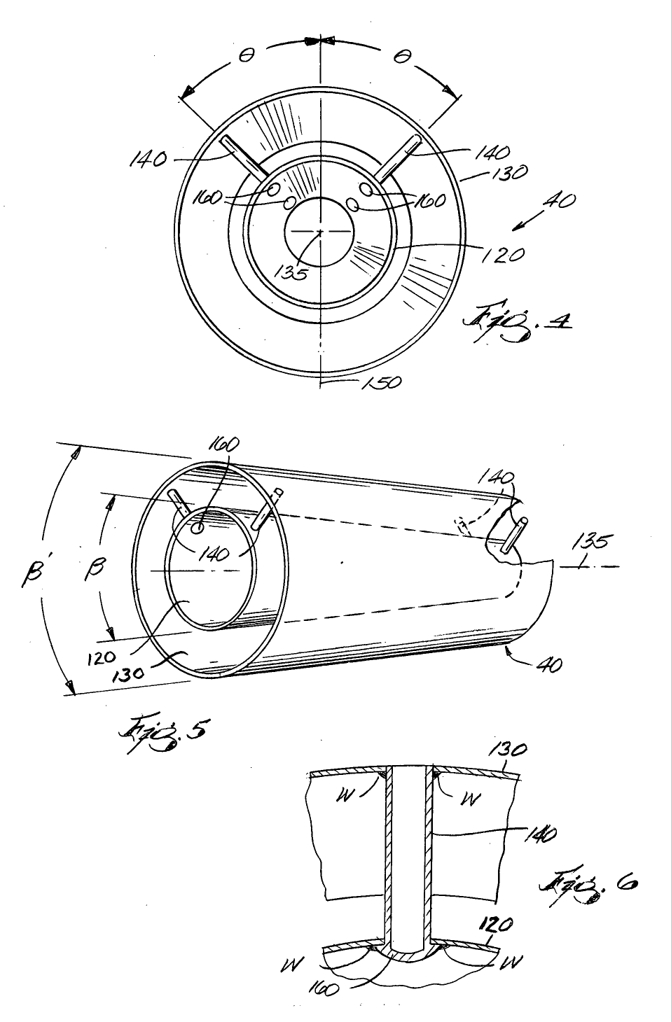

Referring now to FIGS. 4-6, an alternative construction of the diffuser 40 may include two nested conical members, the inner conical member 120 having a diffusion angle β of about 7-10° and the outer conical member 130 having a diffusion angle β′ of about 14-20° such that the angle of the annular space between the inner and outer conical members 120, 130 is about 3.5-5°. The diffuser 40 has a longitudinal axis 135 about which both conical members 120, 130 are centered. In this construction, the diffuser 40 includes two struts 140 at the front end and two struts 140 at the rear end of the diffuser 40. The longitudinal axes of the struts 140 intersect the longitudinal axis 135 of the diffuser 40, and in this regard, the struts 140 may be termed “radial struts.”

The struts 140 in each set are separated about 90° from each other and an angle θ of about 45° on either side of a vertical plane 150 that includes the longitudinal axis 135 of the diffuser 40. The struts 140 are hollow, are constructed of the same or similar material as the conical members 120, 130, and have a wall thickness substantially the same as the wall thickness of the conical members 120, 130. The struts 140 extend through the conical members 120, 130 and are rigidly affixed to the conical members by welding (as at W). A cap 160 is positioned over the inner end of the struts 140 to prevent fluid flow in the diffuser 40 from flowing into the struts 140. Matching the wall thickness of the struts 140 to the wall thickness of the conical members 120, 130 causes the struts and conical members to thermally expand at substantially the same rates, and having two struts 140 extending substantially radially between the conical members 120, 130 provides sufficient structural stability to handle the vibrations expected in the diffuser 40 during normal operation of the engine 5.

Although particular embodiments of the present invention have been shown and described, other alternative embodiments will be apparent to those skilled in the art and are within the intended scope of the present invention. Thus, the present invention is to be limited only by the following claims.

What is claimed is:

1. A combustion turbine engine comprising:
a recuperator having a hot gas flow path and a cool gas flow path;
a compressor providing a flow of compressed gas to the cool gas flow path of the recuperator, the compressed gas being heated within the recuperator;
a source of fuel providing a flow of fuel;
a combustor receiving the heated flow of compressed gas from the recuperator and the flow of fuel from the source of fuel, and combusting a mixture of compressed gas and fuel to produce a flow of hot gas;
a radial flow turbine receiving the flow of hot gas from the combustor and discharging a flow of exhaust gas, the turbine including a rotating element that rotates in response to the flow of hot gas through the turbine;
an electric generator generating electricity in response to rotation of the rotating element of the turbine;
a diffuser receiving the flow of exhaust from the turbine, the diffuser including at least two nested frustoconical members that define at least two separate flow paths for the flow of exhaust through the diffuser, the diffuser having an inlet end defining an inlet flow area, and an outlet end defining an outlet flow area that is larger than the inlet flow area, the diffuser reducing the flow rate of the flow of exhaust as the flow of exhaust flows from the inlet end to the outlet end; and
a plenum delivering the flow of exhaust from the diffuser to the hot gas flow path of the recuperator such that the exhaust gas heats the compressed gas within the recuperator.

2. The engine of claim 1, wherein the plenum receives the flow of exhaust from the diffuser in a first direction and delivers the flow of exhaust to the recuperator in a second direction that is substantially opposite the first direction.

3. The engine of claim 1, wherein the ratio of outlet flow area to the inlet flow area of the diffuser is between about 3 to 1 and about 7 to 1.

4. The engine of claim 1, wherein the ratio of outlet flow area to the inlet flow area of the diffuser is between about 4 to 1 and about 5 to 1.

5. The engine of claim 1, wherein the diffusion angle of each of the at least two separate flow paths in the diffuser is not greater than about 7°.

6. The engine of claim 1, wherein the diffusion angle of the innermost flow path of the at least two separate flow paths of the diffuser is not greater than about 7°, and wherein the diffusion angle of each of the rest of the flow paths in the diffuser is not greater than about 5°.

7. The engine of claim 1, wherein the at least two nested frustoconical members include first, second, third, and fourth frustoconical members; wherein the first frustoconical member defines a first one of the at least two flow paths; wherein the second frustoconical member surrounds the first frustoconical member such that a second one of the at least two flow paths is defined between the first and second frustoconical members;
wherein the third frustoconical member surrounds the second frustoconical member such that a third one of the at least two flow paths is defined between the second and third frustoconical members; and wherein the fourth frustoconical member surrounds the third frustoconical member such that a fourth one of the at least two flow paths is defined between the third and fourth frustoconical members.

8. The engine of claim 7, wherein the first, second, third, and fourth frustoconical members are arranged substantially coaxially with each other.

9. The engine of claim 7, wherein the first flow path has a diffusion angle about 7°, wherein the second and third flow paths each have a diffusion angle of about 3.5°, and wherein the fourth flow path has a diffusion angle of about 0.5°.

10. The engine of claim 1, wherein each of the at least two frustoconical members includes an inner surface and an outer surface, the engine further comprising at least one strut interconnected between the inner surface of one of the frustoconical members and the outer surface of another of the frustoconical members.

11. The engine of claim 10, wherein the strut is substantially tangent to the outer surface to which it is interconnected.

12. The engine of claim 10, wherein the strut permits respective rotation between the frustoconical members while maintaining a substantially constant spacing therebetween.

13. The engine of claim 10, wherein the strut is interconnected with the outer surface by way of a slot in the outer surface, such that the strut is movable within the slot to permit relative movement between the frustoconical members.

14. The engine of claim 1, wherein the at least two frustoconical members includes a plurality of pairs of frustoconical members, each pair consisting of an inner and an outer frustoconical member, the engine further comprising three struts interconnecting an inner surface of each outer frustoconical member to the outer surface of the inner frustoconical member with which it is paired.

15. The engine of claim 14, wherein each strut is substantially tangent to the outer surface to which it is interconnected.

16. The engine of claim 1, wherein the turbine exhausts the exhaust gas at a flow rate of about 800 ft./sec. and wherein the diffuser reduces the flow rate of exhaust gas to about 50 to 100 ft./sec.

17. A diffuser comprising:
at least two nested frustoconical members, each including an inner surface and an outer surface; and
at least one strut interconnected between the inner surface of one of the frustoconical members and the outer surface of another of the frustoconical members;
wherein the strut is substantially tangent to the outer surface to which it is interconnected.

18. The engine of claim 17, wherein the strut permits respective rotation between the frustoconical members while maintaining a substantially constant spacing therebetween.

19. The engine of claim 17, wherein the strut is interconnected with the outer surface by way of a slot in the outer surface, such that the strut is movable within the slot to permit relative movement between the frustoconical members.

20. The engine of claim 17, wherein the at least two frustoconical members includes a plurality of pairs of frustoconical members, each pair consisting of an inner and an outer frustoconical member, and wherein the at least one strut includes three struts interconnecting an inner surface of each outer frustoconical member to the outer surface of the inner frustoconical member with which it is paired.

21. The engine of claim 20, wherein each strut is substantially tangent to the outer surface to which it is interconnected.

22. A combustion turbine engine comprising:
a recuperator having a hot gas flow path and a cool gas flow path;
a compressor providing a flow of compressed gas to the cool gas flow path of the recuperator, the compressed gas being heated within the recuperator;
a source of fuel providing a flow of fuel;
a combustor receiving the heated flow of compressed gas from the recuperator and the flow of fuel from the source of fuel, and combusting a mixture of compressed gas and fuel to produce a flow of hot gas;
a radial flow turbine receiving the flow of hot gas from the combustor and discharging a flow of exhaust gas, the turbine including a rotating element that rotates in response to the flow of hot gas through the turbine;
an electric generator generating electricity in response to rotation of the rotating element of the turbine;
a diffuser receiving the flow of exhaust from the turbine, the diffuser having a longitudinal axis and including inner and outer nested frustoconical members, the inner frustoconical member defining an inner flow path that includes a portion of the longitudinal axis of the diffuser, the inner and outer frustoconical members defining therebetween an outer flow path; and
a plenum delivering the flow of exhaust from the diffuser to the hot gas flow path of the recuperator such that the exhaust gas heats the compressed gas within the recuperator.

23. The engine of claim 22, wherein the outer flow path is annular in shape and is centered around the longitudinal axis.

24. The engine of claim 22, further comprising struts in the diffuser interconnecting the inner conical member and the outer conical member, the struts extending substantially radially away with respect to the longitudinal axis.

25. The engine of claim 24, wherein the struts include a pair of struts in each of the front and rear halves of the diffuser.

26. The engine of claim 25, wherein each pair of struts is disposed about 45° on either side of a vertical plane that includes the longitudinal axis.

27. The engine of claim 24, wherein the struts are tubular and have a wall that is of substantially the same thickness as the walls of the inner and outer conical members.

28. The engine of claim 27, wherein the struts are welded to each of the inner and outer conical members.

29. The engine of claim 28, wherein the struts pierce through each of the inner and outer conical members.

30. The engine of claim 29, further comprising a cap closing off an inner end of each strut and welded to the inner surface of the inner conical member.
